(19) United States
(12) Patent Application Publication
(10) Pub. No.: US 2005/0280943 A1
(43) Pub. Date: Dec. 22, 2005

(54) Slider and rotating disk type storage device

(75) Inventors: Hiroo Inoue, Kanagawa (JP); Taichi Nakamura, Kanagawa (JP); Kazutaka Okasaka, Kanagawa (JP); Akihiro Sera, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/147,799

(22) Filed: Jun. 7, 2005

(30) Foreign Application Priority Data
Jun. 18, 2004 (JP) 2004-180957

(51) Int. Cl. G11B 5/60

(52) U.S. Cl. 360/236.2; 360/235.6; 360/235.7; 360/235.8; 360/236.1; 360/236.3

(57) ABSTRACT

A stable kinetic performance is to be exhibited even in the case of such a small-sized slider as Femto slider. In one embodiment, an air bearing surface (ABS) of a slider comprises a first pad constituting portion extending from a leading edge side to a trailing edge side, a second pad constituting portion and a third pad constituting portion formed on both sides of the first pad constituting portion and extending from the leading edge side to the trailing edge side, a connecting pad for connecting the first, second, and third pad constituting portions on the leading edge side, a first negative pressure portion formed by the first and second pad constituting portions and the connecting pad, a second negative pressure portion formed by the first and third pad constituting portions and the connecting pad, and an air trap portion formed on the leading edge side of the connecting pad.

### CROSS-REFERENCES TO RELATED APPLICATIONS

This application claims priority from Japanese Patent Application No. JP2004-180957, filed Jun. 18, 2004, the full disclosure of which is incorporated herein by reference.

### BACKGROUND OF THE INVENTION

The present invention relates to a slider for use in a rotating disk type storage device and more particularly to a slider able to exhibit a stable kinetic performance.

In a rotating disk type storage device such as a magnetic disk drive or a magnetic optical disk drive, a slider with a head mounted thereon moves while flying over a surface of a rotating disk. A magnetic disk drive will now be described as an example. The slider is supported by a spring structure called a flexure. The flexure is attached to a support structure called a load beam. An assembly comprising the slider, the flexure, and the load beam is designated a head gimbals assembly (hereinafter referred to as “HGA”). The HGA is attached to an actuator performing a pivotal motion with the driving force of a voice coil motor.

The slider has an air bearing surface on its side opposed to a recording surface of a magnetic disk. When the slider flies, the air bearing surface tilts so that an air inlet end rises slightly relative to an air outlet end from the surface of the magnetic disk to form a wedge-like air flow path between the air bearing surface and the magnetic disk surface. When an air flow generated on the magnetic disk surface with rotation of the disk enters the wedge-like flow path, the viscosity of air imparts pressure (“positive pressure” hereinafter) to the air bearing surface in a direction to raise the slider from the disk surface.

On the other hand, the load beam imparts a force (“pushing load” hereinafter) to the slider through the flexure in a direction to push the slider against the magnetic disk surface. A certain air bearing surface has a construction for generating a force (“negative pressure” hereinafter) in a direction in which the air flow attracts the slider to the disk surface. In this case, the slider flies from disk surface at a position and posture at which the positive and negative pressures and the pushing load are balanced, and maintains the spacing between the disk surface and the head in a predetermined range. The negative pressure enhances air rigidity under an interaction with the positive pressure. The air rigidity means a property such that the flying posture of the slider is difficult to change even if an external impact force or a certain force acting through the load beam or the flexure is applied to the slider.

A change in the air flow caused by undulation of the magnetic disk which is rotating or by collision of the disk with an actuator arm, and a seek motion of the head by an actuator, act to change the flying posture of the slider. In a magnetic disk drive adopting the load/unload method, there sometimes occurs a case where the flying posture of the slider becomes unstable just after loading over the surface of the magnetic disk from a ramp. A change in flying posture of the slider causes a change in pressure distribution which the air bearing surface receives from the air flow. When the flying posture of the slider tilts in either pitch direction or roll direction from a predetermined normal flying posture, the flexure functions to restore the flying posture to the original posture by virtue of a spring action and maintain the distance between the head and the disk surface in a predetermined range. When the flying posture of the slider changes, the slider performs, under the spring action of the flexure, “pivotal motions” or “pitch and roll motions” (“gimbaled motions” hereinafter) around a dimple formed in the load beam or the flexure so as to maintain the flying height of the head in a predetermined range. The “normal flying posture” as referred to herein means an ideal flying posture, when the slider flies from the surface of the magnetic disk.

In the magnetic disk drive, a pitch static attitude and a roll static attitude are determined as values defining an ideal posture of the slider relative to the surface of the magnetic disk when HGA is positioned so as to let the head lie at a predetermined flying height in a state of non-rotation of the magnetic disk after assembly of HGA and magnetic disk within a disk enclosure. Likewise, a pitch dynamic attitude and a roll dynamic attitude are determined as values defining a flying posture of the slider relative to the disk surface in a rotating state of the magnetic disk. The pitch attitude means an elevation angle, i.e., an angle between the length direction (pitch direction) of the slider in which the slider flies while receiving the air flow and the plane of the magnetic disk. The roll attitude means an angle between the width direction (roll direction) of the slider and the plane of the magnetic disk.

Further, tolerances as allowable ranges as product are defined for the pitch static attitude and the roll static attitude of the slider. If the production and assembly of the slider are performed so that the slider can take a posture falling under the tolerance of the pitch static attitude and that of the roll static attitude, the slider, when flying over the surface of the magnetic disk, can perform appropriate gimbaled motions and maintain the spacing between the head and the disk surface. The flying posture of the slider over the magnetic disk is influenced by the pressure distribution which the air bearing surface receives from the air flow. Therefore, in order for the slider to fly while performing appropriate gimbaled motions, it is desirable that the pressure distribution of the air bearing surface during flying of the slider should not so much deviate from the pressure distribution of the air bearing surface in the normal flying posture.

FIG. 9 shows the shape of an air bearing surface of a conventional two-pad type slider 110. The air bearing surface has a leading edge 111 as an air inlet end and a trailing edge 113 as an air outlet end. Two pads 115 and 117 projecting from a reference plane 127 are formed. On the leading edge 111 side the two pads 115 and 117 are connected with each other through a pad 119. A negative pressure portion 129 is formed in part of the reference plane 127 surrounded by the pads 115, 117, and 119. A pad 121 projecting from the reference plane 127 is formed on the trailing edge 113 side of the air bearing surface. A head 123 for performing read and/or write of data is formed in the pad 121. A step 112 is formed between the leading edge 111 and the pad 119. Side rails 116 and 118 are formed on the trailing edge 113 sides of the pads 115 and 117, respectively. Further, a center rail 122 is formed on the pad 119 side of the pad 121.

Various proposals have been made as to the slider in such a rotating disk type storage device. For example, a negative pressure air lubrication bearing slider is disclosed in Japanese Patent Laid-open No. 2002-32905 (Patent Document 1). This slider includes a body adapted to fly in a first direction while floating a predetermined height along tracks of an information recording disk, plural rails provided on a bottom of the body opposed to a disk surface, an air inlet channel disposed in the first direction of the bottom of the body and having an air inlet portion extending from a front end of the slider and an air outlet portion extending toward the inside of the body. This slider further includes a set of negative pressure cavity portions in a second direction (roll direction) perpendicular to the first direction (pitch direction) centered on the air inlet channel.

Moreover, a head slider is disclosed in Japanese Patent Laid-open No. 2001-167417 (Patent Document 2). This head slider includes a rail portion projecting on a surface opposed to a moving recording medium surface and having an air bearing surface which receives a flying pressure relative to the recording medium surface from an air flow entering between the recording medium surface and the opposed surface. In this head slider, at least all of the peripheral edge portion of the rail portion opposed to the inflow direction of the air flow has such a contour shape as convexly curved against the inflow direction.

A thin film magnetic head is disclosed in Japanese Patent Laid-open No. 2002-150506 (Patent Document 3). This thin film magnetic head has a construction such that a shielding layer formed on one end face of a substrate so as to have a slant face which is inclined at a required angle relative to the one end face, an MR head and an inductive type head are formed on the slant face, and magnetic gap surfaces of both heads are not in parallel with the one end face of the substrate.

Further, a thin film magnetic head is disclosed in Japanese Patent Laid-open No. 2002-237020 (Patent Document 4). In this thin film magnetic head, a corner portion on an ABS side of a substrate, which is apt to contact a recording medium, is formed in the shape of an arcuate face having a radius of 10 μm or more or in a chamfered shape.

### BRIEF SUMMARY OF THE INVENTION

With the recent tendency to an increase in recording density and a decrease in size of magnetic disks, sliders have also been becoming smaller in size. Femto slider defined in IDEMA (International Disk Drive Equipment and Materials Association) is beginning to be used practically. Femto slider is in the shape of a rectangular parallelepiped having external dimensions of 0.7 mm×0.85 mm×0.23 mm, which is smaller than that of the conventional Pico slider (1.0 mm×1.25 mm×0.3 mm). Femto slider is smaller than Pico slider also in the area of an air bearing surface. As the area of an air bearing surface of a slider becomes smaller, the amount of a negative pressure also becomes smaller. Therefore, in order to prevent deterioration in follow-up performance for the surface of a magnetic disk, it is necessary that the amount of a positive pressure and the spring constant of a flexure be set small to keep a flying posture in a well-balanced state.

In the case of a flexure having a small spring constant, the ability to correct the posture of a slider in gimbaled motions is deteriorated. An air bearing surface of a slider is formed so as to afford such a pressure distribution as enables the most stable kinetic performance to be exhibited in a normal flying posture. Therefore, if the pressure distribution on the air bearing surface in a flying posture is greatly different from that in the normal flying posture, it becomes virtually impossible for the slider to perform proper gimbaled motions, with consequent deterioration in the reliability of read/write operations of the head or the occurrence of an unexpected collision of the slider with the magnetic disk. A solution to this problem may be improving the manufacturing accuracy of HGA and a relative assembling accuracy thereof with respect to the magnetic disk, making the pitch static attitude tolerance and the roll static attitude tolerance more strict to diminish displacement, and diminishing a pressure variation of the air bearing surface in a flying posture relative to the normal flying posture. However, such a solution encounters a limit in both cost and technical aspect. Forming the air bearing surface of the slider in such a manner that the variation in pressure distribution in a flying posture of the slider becomes minimum as compared with that in the normal flying posture is effective in improving the kinetic performance of the slider.

FIGS. 10(A) to 10(E) show the results of having simulated pressure distributions of an air bearing surface of the same shape as in FIG. 9 in terms of mathematical models in flying postures of a two-pad type Femto slider 110 having the air bearing surface in displaced conditions of the pitch static attitude and the roll static attitude up to maximum tolerances. FIG. 10(A) shows a pressure distribution of the air bearing surface when the slider 110 is in the normal flying posture. When the slider 110 flies over the magnetic disk which is rotating, an air flow advances in the direction of arrow 125 into a wedge-like air flow path formed by the air bearing surface and the surface of the magnetic disk. The flying posture of the slider shown in FIG. 10(A) tilts so that the spacing between the magnetic disk surface and the leading edge 111 is a little larger than the spacing between the disk surface and the trailing edge 113.

In the flying posture shown in FIG. 10(A), the slider 110 has a pitch static attitude slightly positive relative to the surface of the magnetic disk, but a roll static attitude relative to the disk surface is almost zero. FIG. 10(B) shows a pressure distribution in a flying posture of the slider 110 in which the roll static attitude of the slider 110 lies in the positive-side tolerance. At this time, the slider 117 tilts so that the pad 117 is closer to the disk surface than the pad 115. FIG. 10(C) shows a pressure distribution in a flying posture of the slider 110 in which the roll static attitude lies in the negative-side tolerance. At this time, the slider 110 tilts so that the pad 115 is closer to the disk surface than the pad 117.

FIG. 10(D) shows a pressure distribution in a flying posture of the slider 110 in which the pitch static attitude of the slider lies in the negative-side tolerance. At this time, the slider 110 tilts so that the leading edge 111 is closer to the disk surface than the trailing edge 113 in comparison with the normal flying posture shown in FIG. 10(A). FIG. 10(E) shows a pressure distribution in a flying posture of the slider 110 in which pitch static attitude of the slider lies in the positive-side tolerance. At this time, the slider 110 tilts so that the trailing edge 113 is closer to the disk surface than the leading edge 111 in comparison with the normal flying posture shown in FIG. 10(A).

In FIG. 10(A), the positions indicated at P represent pressure centers of positive pressures developed in the two pads 115 and 117 of the slider 110. The position indicated at N represents a pressure center of a negative pressure acting to attract the slider 110 to the surface of the magnetic disk. Also in the other figures the reference marks P and N are used in the same sense. When FIGS. 10(A), (D), and (E) are compared with one another, it is seen that when the pitch static attitude of the slider 110 is inclined up to a maximum positive-side tolerance, the positive pressure centers P on the pad 117 shift to the trailing edge 113 side. This is presumed to cause a change of the flying posture. When FIGS. 10(A), (B), and (D) are compared with one another, it is seen that when the slider 110 tilts in the roll direction, the position of P on the pad 115 and that of P on the pad 117 are distributed so as to cause the slider 110 to be twisted. This is presumed to change the flying posture of the slider to a greater extent than when the slider tilts in the pitch direction.

When the flying posture changes, the slider 110 comes into unexpected contact with the magnetic disk, or due to a change in flying height of the head it becomes virtually impossible to effect a magnetic interaction between the recording surface of the magnetic disk and the head with consequent deterioration in the reliability of read and write. Particularly in such a small-sized slider as Femto slider the flexure cannot correct the posture to a satisfactory extent due to a small spring constant, so that a change in pressure distribution becomes more influential. The magnetic interaction between the recording surface of the magnetic disk and the head means read of data or overwrite of data.

In the negative pressure air lubrication bearing slider disclosed in Patent Document 1, a change in roll dynamic attitude due to the roll static tolerance can be suppressed by a set of negative pressure cavity portions distributed in the roll direction, so that the flying stability can be improved to some extent. However, since the rail for producing a positive pressure formed on the air inlet side is cut by the air inlet channel having an air inlet portion extending from the front end of the slider and an air outlet portion extending to the inside of the body, the amount of a negative pressure produced decreases and the amount of a positive pressure present in the central portion of the slider decreases remarkably. Therefore, in case of applying this technique to Femto slider with a small amount of air introduced, it is difficult to suppress a change in pitch dynamic attitude attributable to the pitch static attitude tolerance.

Accordingly, it is a feature of the present invention to suppress changes in pitch dynamic attitude and roll dynamic attitude attributable to the pitch static attitude tolerance and the roll static attitude tolerance, respectively, and provide a slider having an air bearing surface structure able to exhibit a stable kinetic performance. It is another feature of the present invention to provide a slider having an air bearing surface structure able to exhibit a stable kinetic performance even in case of the slider being such a small-sized slider as Femto slider. It is a further feature of the present invention to provide a rotating disk type storage device including a slider having such a characteristic.

Principles of the present invention reside firstly in concentrating positive pressure-generating pads on a leading edge side on an air bearing surface to suppress a change in pitch dynamic attitude attributable to the pitch static attitude tolerance of the slider and suppress a change in pressure distribution in the pads, secondly in dispersing a negative pressure portion in the roll direction on the leading edge side to strengthen the air rigidity against roll, and thirdly in forming an air trap portion on the leading edge side of the pads to increase a positive pressure on the leading edge side and thereby compensate for the positive pressure on the leading edge side which is apt to become deficient in a small-sized slider.

In a first aspect of the present invention, there is provided a slider for use in a rotating disk type storage device, the slider having an air bearing surface, the air bearing surface comprising a first pad constituting portion extending from a leading edge side to a trailing edge side, second and third pad constituting portions disposed on both sides of the first pad constituting portion and extending from the leading edge side to the trailing edge side, a connecting pad for connecting the first, second, and third pad constituting portions on the leading edge side, a first negative pressure portion formed by the first and second pad constituting portions and the connecting pad, a second negative pressure portion formed by the first and third pad constituting portions and the connecting pad, and an air trap portion formed on the leading edge side of the connecting pad.

The air bearing surface according to embodiments of the present invention includes first, second, and third pad constituting portions which are concentrated on the leading edge side. In connection with the area of the air bearing surface compared with that in the conventional slider, pads are concentrated on the leading edge side to produce about the same degree of a positive pressure as in the conventional slider and the lengths of the pads in an air flow path direction are made short. Therefore, it is possible to suppress a change in pressure distribution in each area of the pads. Thus, the positive pressure does not decrease as a whole in comparison with the conventional slider, and it is not necessary to decrease the pushing load of the load beam, so that there is no fear of deterioration in impact resistance of the magnetic disk drive.

A change in pressure distribution upon displacement of the slider posture is difficult to become such a pressure distribution as causes a change of the flying posture of the slider, because it can move only within the plane of the pads dispersed in the roll direction on the leading edge side. Since the connecting pad for connecting the first, second, and third pad constituting portions on the leading edge side is provided, it is possible to form first and second negative pressure portions. Negative pressures produced in the first and second negative pressure portions enhance the air rigidity in the roll direction and improve the stability of the slider posture in the roll direction.

By providing an air trap portion on the leading edge side of the connecting pad, an air flow entering from the leading edge stays or is trapped in the air trap portion and the air present therein can be conducted in a larger amount and concentratively to each pad constituting portion. Consequently, the positive pressure produced on the leading edge side can be further increased, and it is possible to maintain the pitch attitude tolerances. Moreover, since the pushing load of the load beam can be increased by an amount corresponding to the increase of the positive pressure, it is possible to further improve the impact resistance. The provision of the air trap portion in the slider is effective also in maintaining the pitch dynamic attitude in the case where it is difficult to obtain a large positive pressure as in a storage device wherein the flow velocity of an air flow is low due to a small diameter of a magnetic disk used or due to a small number of revolutions.

The air trap portion is formed as a creek or an inlet by cutting the leading edge side of the connecting pad in V or U shape or a rectangular shape. One air trap portion may be provided at a position corresponding to the first pad constituting portion, two air trap portions may be provided at positions corresponding to the second and third pad constituting portions, or three air trap portions may be provided at positions corresponding to the first, second, and third pad constituting portions. Thus, the positive pressure on the leading edge side can be increased without the slider being rolled by a positive pressure resulting from compression of air in the air trap portion(s). Since the air trap portion is formed like a creek or an inlet, even if a skew angle occurs when the slider moves on inner and outer periphery sides of the magnetic disk with a consequent change in the angle of the air flow relative to the leading edge, it is possible to maintain the positive pressure. If the first, second, and third pad constituting portions terminate on the leading edge side with respect to a middle position between the leading edge and the trailing edge, changes in pressure distribution can be limited to that range.

According to the present invention, since changes in pitch dynamic attitude caused by the pitch static attitude tolerance and in roll dynamic attitude caused by the roll static attitude tolerance can be suppressed, it is possible to provide a slider having an air bearing surface structure able to exhibit a stable kinetic performance. It is also possible to provide a slider having an air bearing surface structure able to exhibit a stable kinetic performance even in case of the slider being a small-sized slider like Femto slider. Further, it is possible to provide a rotating disk type storage device including a slider having such a feature.

### BRIEF DESCRIPTION OF THE DRAWINGS

FIGS. 1(A) and 1(B) show the construction of a slider used in a rotating disk storage device according to one embodiment of the present invention, in which (A) is a perspective view and (B) is a front view of an air bearing surface.

FIG. 2 is a plan view showing a schematic construction of the magnetic disk drive of FIG. 1.

FIG. 3 is a plan view showing a flexure supporting the slider.

FIG. 4 is a side view of the flexure.

FIGS. 5(A) to 5(E) are explanatory diagrams showing pressure distributions obtained when a roll static attitude of the slider relative to the magnetic disk is inclined up to a positive-side tolerance and a negative-side tolerance and a pressure distribution obtained when a pitch static attitude of the slider relative to the magnetic disk is inclined up to a positive-side tolerance and a negative-side tolerance.

FIGS. 6(A) and 6(B) are front views of an air bearing surface of a slider according to another embodiment of the present invention.

FIGS. 7(A) to 7(C) are front views of an air bearing surface of a slider according to a further embodiment of the present invention.

FIGS. 8(A) to 8(c) are front views of an air bearing surface of a slider according to a still further embodiment of the present invention.

FIG. 9 is a perspective view of a conventional slider.

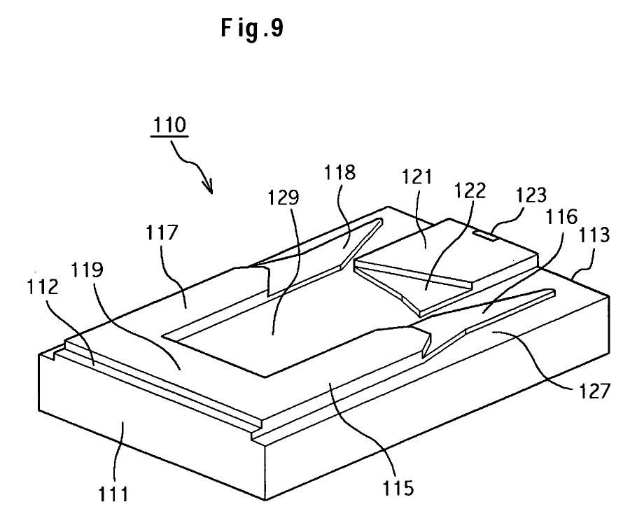

FIGS. 10(A) to 10(E) are explanatory diagrams showing pressure distributions obtained when a roll static attitude of the conventional slider relative to a magnetic disk is inclined up to a positive-side tolerance and a negative-side tolerance and a pressure distribution obtained when a pitch static attitude of the conventional slider relative to the magnetic disk is inclined up to a positive-side tolerance and a negative-side tolerance.

### DETAILED DESCRIPTION OF THE INVENTION

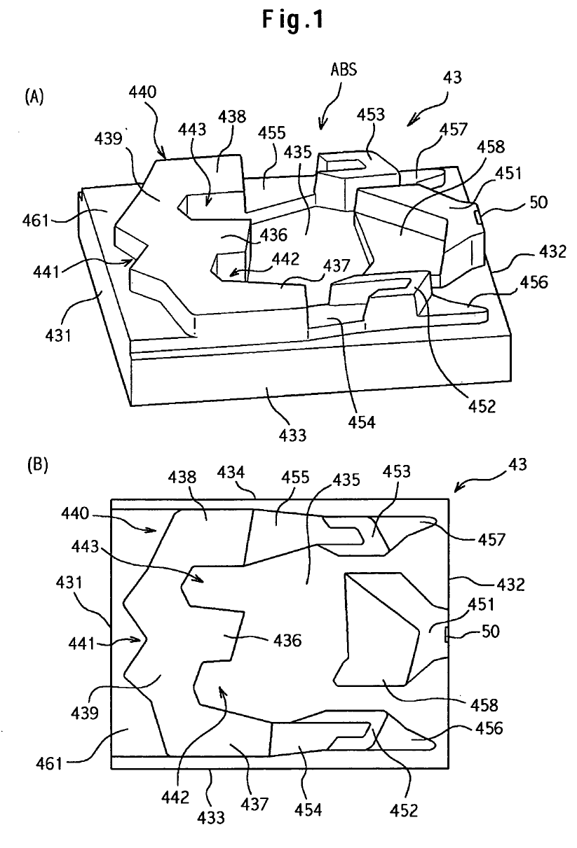

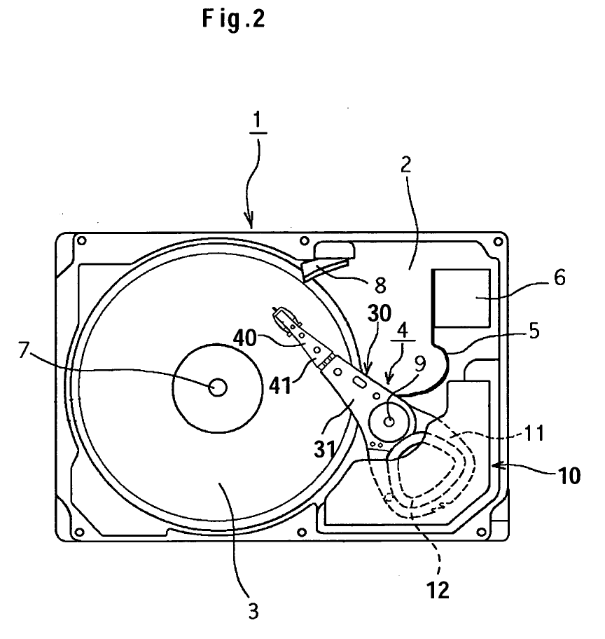

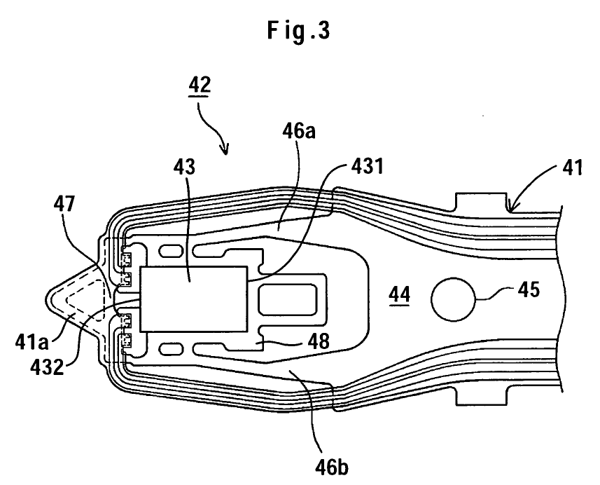

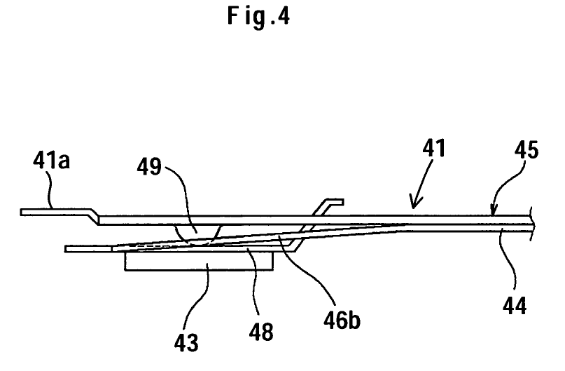

FIGS. 1(A) and 1(B) show the construction of a slider according to one embodiment of the present invention, in which FIG. 1(A) is a perspective view and FIG. 1(B) is a plan view. FIG. 2 is a plan view showing a schematic construction of a magnetic disk drive according to the present invention. FIG. 3 is a plan view of a flexure as seen from a magnetic disk side. FIG. 4 is a side view showing a schematic structure of a side face of the flexure illustrated in FIG. 3.

A magnetic disk drive as an example of a rotating disk type storage device according to the present embodiment includes as follows. As shown in FIG. 2, a magnetic disk 3 as a rotating disk type storage medium, a spindle motor (not shown), and an actuator head suspension assembly (hereinafter referred to as “AHSA”) 4 are accommodated within a disk enclosure 1. The enclosure 1 has a hermetically sealed space formed by a base 2 and a cover (not shown) covering the base 2 from above. A flexible cable 5 and an external connecting terminal 6 attached to the cable 5 are installed in the base 2, and a circuit board (not shown) provided outside the disk enclosure 1 is connected to the external connecting terminal 6.

The magnetic disk 3 is a single disk or comprises plural stacked disks and is fixed to an outer periphery of a spindle shaft 7 of a spindle motor erected on the base 2. Both surfaces of the magnetic disk 3 form thereon recording surfaces respectively. In case of using plural stacked disks, the disks are attached in a stacked state to a spindle hub (not shown) at predetermined spacings so as to be integrally rotatable around the spindle shaft 7.

The AHSA 4 includes an actuator assembly 30 and an HGA 40. The actuator assembly 30 includes an actuator arm 31 supporting the HGA 40, a bearing portion of a pivot shaft 9, and a VCM 10. The VCM 10 includes a coil support 11, a voice coil 12 supported by the coil support 11, a voice coil magnet, and upper and lower yokes (not shown).

As shown in FIGS. 2 and 3, the HGA 40 includes a load beam 41, a flexure 42, and a slider 43. The load beam 41 supports the slider 43 through the flexure 42 and imparts a pushing load to the slider 43. A tab 41a is provided in a projecting state at an extreme end of the load beam 41. A ramp 8 is mounted to the base 2 outside and near the magnetic disk 3. The ramp 8 is adopted in the load/unload method which is one of methods for providing an unload place to the slider 43. The AHSA 4 turns outside before stopping the rotation of the magnetic disk 3, and the tab 41a comes into engagement with the ramp 8, allowing the slider 43 to be unloaded from the surface of the magnetic disk 3.

The flexure 42 is attached to the extreme end side of the load beam 41. When the slider 43 flies over the surface of the magnetic disk, the flexure 42 maintains the flying height of the head in a predetermined range while allowing the slider to perform gimbaled motions. In the flexure 42, as shown in FIGS. 3 and 4, a part of a support area 44 is spot-welded at 45 on the support end side of the load beam 41. A pair of arms 46a and 46b extend from the support area 44 toward the extreme end of the load beam 41 and become integral with each other in an extreme-end area 47. Further, the flexure 42 is provided with a flexure tongue 48 which is formed so as to be supported by the extreme-end area 47 and the arms 46a and 46b. A dimple contact point (DCP) (not shown) is defined nearly centrally of the flexure tongue 48. The slider 43 is fixed in such a manner that the DCP is positioned nearly centrally. Therefore, while being supported by the flexure 42, the slider 43 flies over the recording surface of the magnetic disk and performs a follow-up operation for tracks while performing soft gimbaled motions.

As shown in FIGS. 1(A) and 1(B), the slider 43 supported by the flexure 42 has a machined shape which is generally rectangular parallelepiped, and has an air bearing surface (ABS). The ABS is provided with a leading edge 431 as an air flow inlet end and a trailing edge 432 as an air flow outlet end. A flat area formed on the ABS side and surrounded by the leading edge 431, the trailing edge 432, a first side edge 433, and a second side edge 434 is designated a reference plane 435. The first and second side edges 433 and 434 are positioned on both side ends with respect to the edges 431 and 432.

The ABS of the slider 43 includes plural pads projecting a predetermined height from the reference plane 435. More specifically, the ABS includes a leading pad 440 formed on the leading edge side on the reference plane 435. The leading pad 440 has two creeks on the trailing edge side and one creek on the leading edge side. For example, the leading pad 440 includes a first pad constituting portion 436, a second pad constituting portion 437, and a third pad constituting portion 438. The first pad constituting portion 436 extends from the leading edge 431 side to the trailing edge 432 side. The second and third pad constituting portions 437 and 438 are disposed on both sides of the first pad constituting portion 436 and extending from the leading edge 431 side to the trailing edge 432 side. The first, second, and third pad constituting portions 436, 437, and 438 are connected together on the leading edge 431 side through a connecting pad 439. A generally V-shaped air trap portion 441 as a creek is formed in the sided face on the leading edge 431 side of the connecting pad 439. Thus, the first, second, and third pad constituting portions 436, 437, and 438 and the connecting pad portion 439 are formed in W shape.

Upper surfaces of the first, second, and third pad constituting portions 436, 437, 438, and 439 which constitute the leading pad 440 lie on the same plane. A step 461 having a flat surface is formed between the leading pad 440 and the leading edge 431 so as to be higher than the reference plane 435 and lower than the upper surface of the leading pad 440. On the trailing edge 432 side of the leading pad 440, first and second negative pressure portions 442 and 443 are formed as creeks. The first negative pressure portion 442 is surrounded by the first and second pad constituting portions 436 and 437 and the connecting pad 439. The second negative pressure portion 443 is surrounded by the first and third pad constituting portions 436 and 438 and the connecting pad 439.

Thus, the leading pad 440 is dispersed into the first, second, and third pad constituting portions 436, 437, and 438, which are concentrated on the leading edge side. Therefore, a positive pressure can be produced on the leading edge side in comparison with the conventional slider. As a result, upon displacement in the posture of the slider 43, a change in pitch dynamic attitude caused by the pitch static attitude tolerance, which is attributable to the manufacture or assembly, can shift only within the surface of the pad which is dispersed in the roll direction on the leading edge side and whose length in the air flow path direction has become shorter. That is, in the leading pad 440, the lengths in the air flow path direction at positions corresponding to the pad constituting portions 436, 437, and 438 become shorter than in the conventional positive pressure pads. Accordingly, the flying posture of the slider 43 in the pitch attitude direction can be stabilized, and a stable kinetic performance is exhibited in gimbaled motions. Also, negative pressure portions are formed on the first side edge 433 side, and the second side edge 434 side and are thus dispersed in the roll direction. The flying posture of the slider 43 in the roll attitude direction becomes stable, and it is possible to enhance the air rigidity against roll. Further, since the air trap portion 441 is formed on the leading edge 431 side of the leading pad 440, an air flow entering the air trap portion 441 from the leading edge stays therein. The air present therein can be conducted in a larger amount and concentratively to each pad constituting portion. Therefore, the positive pressure produced concentratively on the leading edge 431 side by the pad constituting portions 436, 437, and 438 which are dispersed in the roll direction can be increased, and the flying posture of the slider 43 in the pitch attitude direction can be made stabler. Moreover, if the air trap portion 441 is formed like a creek or an inlet, the length of the leading pad 440 which receives the air flow changes little between the time when a skew angle occurs and the time when no skew angle occurs, and therefore the amount of a positive pressure produced also scarcely changes. Thus, the influence on the skew angle can be diminished and hence it becomes easier to control the slider. The skew angle means an angle occurring between the longitudinal direction of the slider and a tangential direction of tracks on the magnetic disk, when the slider moves on the inner or outer periphery side of the magnetic disk.

The whole of the leading pad 440 is formed on the leading edge side with respect to a middle position between the leading edge 431 and the trailing edge 432. By thus forming the leading pad 440 on the leading edge side, a change in pressure distribution substantially in the air flow direction of the slider can be limited to a narrower range than in the conventional art. In the ABS of the slider 43, a center pad 451 is formed on the trailing edge 432 side with respect to the middle position between the leading edge 431 and the trailing edge 432. A magnetic head 50 for reading data from the magnetic disk 3 is attached to the trailing edge 432 side of the center pad 451 and thus the center pad 451 functions as a pad for the head. The magnetic head 50 can read and write data with the magnetic disk 3 by making two-way conversion between an electric signal and a magnetic signal. The magnetic head 50 may be constituted by a read-only magnetic head alone.

Further, in the ABS of the slider 43, a first side pad 452 and a second side pad 453 are formed on the trailing edge 432 side with respect to the middle position between the leading edge 431 and the trailing edge 432. The first and second side pads 452 and 453 are formed on both sides of the center pad 451. The first and second side pads 452 and 453 are each formed in a generally U shape so that the recess portion is open to the leading edge 431 side. The leading pad 440, center pad 451, first side pad 452, and second side pad 453 produce positive pressures on the leading edge 431 side, trailing edge 432 side, first side edge 433 side, and second side edge 434 side of the slider 43, respectively. By virtue of the positive pressures thus produced in those positions, the negative pressures produced in the first and second negative pressure portions 442 and 443, the pushing load from the load beam 41, and the spring action of the flexure 42, the slider 43 can perform stable gimbaled motions while maintaining the spacing between the head 50 and the magnetic disk 3 within a predetermined range.

Between the second pad constituting portion 437 and the first side pad 452 is formed a first side rail 454 so as to provide a connection between the two. Likewise, between the third pad constituting portion 438 and the second side pad 453 is formed a second side rail 455 so as to provide a connection between the two. A first tail side rail 456 and a second tail side rail 457 are formed respectively on the trailing edge side 432 of the first side pad 452 and on the trailing edge side 432 of the second side pad 453. Further, a center rail 458 is formed on the first pad constituting portion 436 side of the center pad 451. The first and second side rails 454 and 455, the first and second tail side rails 456 and 457, and the center rail 458 have flat surfaces whose height from the reference plane 435 is the same as that of the step 461. The center pad 451 and the center rail 458 are formed spacedly from the other pads on the reference plane 435.

The first and second side rails 454 and 455, the first and second tail side rails 456 and 457, and the center rail 458 are constructed so as to smooth the flowing of the air flow created between the ABS and the surface of the magnetic disk 3 and thereby keep the flying posture of the slider in good condition. The actuator arm 31 and HGA 40 in the AHSA 4 are stacked correspondingly to the recording surfaces of magnetic disks 3 to afford a head stack assembly.

Next, the operation of the magnetic disk drive adopting the slider 43 will be described mainly with respect to the flying motion of the slider. When the rotation of the magnetic disk 3 is OFF, the tab 41a of the AHSA 4 assumes the unload position on the ramp 8. Now, the spindle motor is turned ON to rotate the magnetic disk (or a stack thereof) 3, and the voice coil motor is turned ON to rotate the AHSA 4 toward the magnetic disk 3, thereby loading the slider 43. As a result, the tab 41a moves away from the ramp 8 while sliding on the slide surface of the ramp 8.

If there is no air flow when the slider 43 is loaded, the posture of the slider lies within the range of the pitch static attitude tolerance and the roll static attitude tolerance, and the slider starts gimbaled motions immediately under the action of an air flow. For performing proper gimbaled motions it is necessary for the slider 43 to assume a stable flying posture just after loading. The flying posture of the slider 43 just after loading from the ramp 8 is apt to become unstable because of a shift from the state in which the slider is supported by the flexure 42 to the state in which the slider undergoes the action of the air flow. It is necessary for the slider 43 to ensure an appropriate pitch dynamic attitude so as to form a wedge-like flow path on both ABS and disk surface just after loading.

In the case of such a small-sized slider as Femto slider there sometimes occurs a case where the positive pressure on the leading edge 431 side becomes deficient. Further, the flying posture of the slider may be changed by the air flow, resulting in the slider coming into contact with the disk surface. With the step 461 in the slider 43, the air flow which has entered the slider from the leading edge 431 advances smoothly up to the surface of the leading pad 440, and a positive pressure is ensured by the leading pad 440. In addition, the air trap portion 441 formed in the leading pad 440 can conduct the air staying therein to each pad constituting portion in a larger quantity and concentratively. The flying posture of the slider 43 becomes stabler, and it becomes possible to avoid contact of the slider 43 with the surface of the magnetic disk 3.

In the leading pad 440, since the pad constituting portions 436, 437, and 438 which produce a positive pressure are concentrated on the leading edge 431, a change in positive pressure relative to the normal flying posture can be diminished while ensuring the positive pressure as a whole, and the slider 43 can maintain a stable flying posture while performing gimbaled motions. The ability to ensure the positive pressure of the slider 43 corresponds to the ability to ensure the pushing load of the load beam 41. This is desirable because it is possible to enhance the air rigidity of the slider and ensure the impact resistance of the magnetic disk drive 1. In case of using Femto slider smaller in size than Pico slider or in case of using the magnetic disk 3 lower in peripheral velocity than a normal peripheral velocity or having a small diameter, the tendency to deficiency of the positive pressure becomes more conspicuous. In such a case, the construction of ABS of the slider 43 is effective.

Even if the posture of the slider 43 changes to its flying posture in the pitch static attitude tolerance or the roll static attitude tolerance relative to the normal flying posture for some reason relating to manufacture or assembly, the pressure distribution in this state is not so different from the pressure distribution in the normal flying posture as compared with the conventional slider, a force which causes the slider 43 to be twisted or tilt in a specific direction is not exerted on the slider, and the slider can perform gimbaled motions stably. Further, negative pressures developed in the first and second negative pressure portions 442 and 443 cooperate with the positive pressures acting on the second and third pad constituting portions 437 and 438 to enhance the air rigidity in the roll direction and thereby improve the stability of the flying posture of the slider 43 in the roll direction. Consequently, it is possible to suppress a change in pitch dynamic attitude due to the pitch static attitude tolerance of the slider 43 and a change in roll dynamic attitude due to the roll static attitude tolerance.

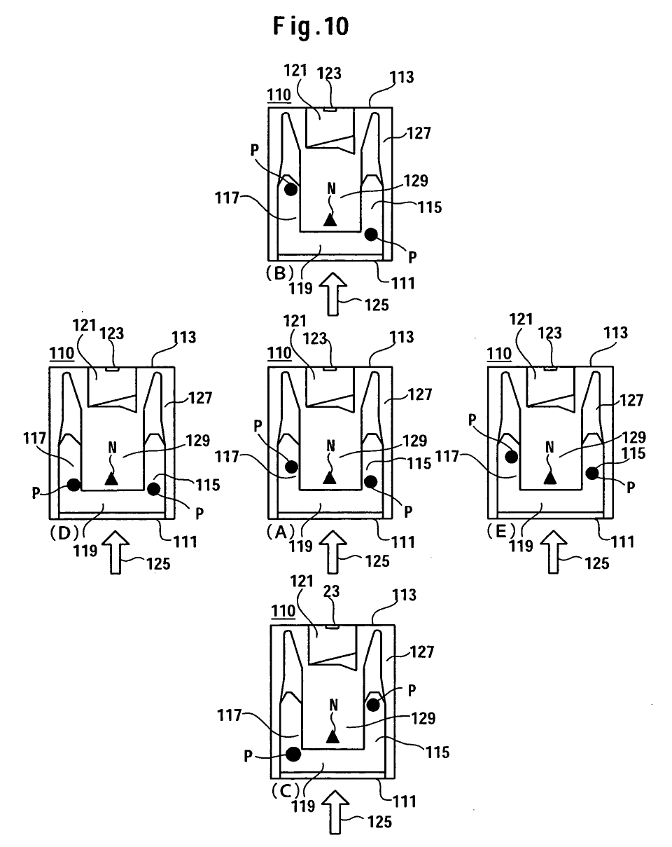

Next, reference will be made to the results of having simulated pressure distributions of ABS in terms of mathematical models using Femto slider as the slider 43 constructed as above and in a displaced state of both pitch static attitude and roll static attitude up to maximum tolerances like the mathematical models shown in FIGS. 10(A) to 10(E). The trailing edge 432 and the leading edge 431 are each 700 μm in length, and the first and second side edges 433 and 434 are each 850 μm in length. The leading pad 440, the center pad 451, and the first and second side pads 452 and 453 are each 940 nm high from the reference plane 435. Likewise, the step 461, the first and second side rails 454 and 455, the first and second tail side rails 456 and 457, and the center rail 458 are each 820 nm high from the reference plane 435.

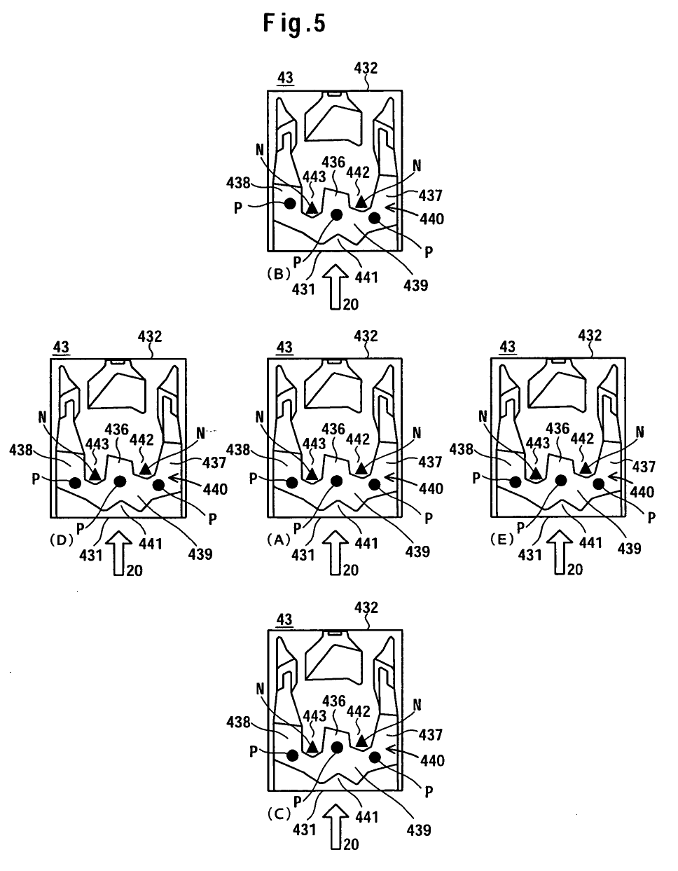

FIGS. 5(A) to 5(E) show the results of having simulated a pressure distribution obtained when the roll static attitude of the slider 43 relative to the magnetic disk 3 is inclined or displaced up to the positive- and negative-side tolerances and a pressure distribution obtained when the pitch static attitude of the slider 43 relative to the magnetic disk 3 is inclined or displaced up to the positive- and negative-side tolerances. FIG. 5(A) shows a pressure distribution of ABS, when the slider assumes the normal flying posture. According to this pressure distribution, the slider 43 exhibits the stablest kinetic performance in its normal flying posture. In FIG. 5(A), the positions indicated at P are pressure centers of positive pressures developed at positions corresponding to the three pad constituting portions 436, 437, and 438 of the leading pad 440 out of the positive pressures developed in the leading pad 440 formed in W shape. The positions indicated at N are pressure centers of negative pressures developed in the first negative pressure portion 442 surrounded by the first and second pad constituting portions 436 and 437 and the connecting pad 439 in the leading pad 440 and developed in the second negative pressure portion 443 surrounded by the first and third pad constituting portions 436 and 438 and the connecting pad 439. The reference marks P and N are used in the same sense also in the other figures.

When the slider 43 flies over the magnetic disk 3 which is rotating, the air flow advances in the direction of arrow 20 and enters the wedge-like air flow path formed by both ABS and disk surface. The posture of the slider 43 in FIG. 5(A) tilts so that the spacing between the surface of the magnetic disk 3 and the leading edge 431 becomes a little larger than the spacing between the disk surface and the trailing edge 432. In the normal flying posture shown in FIG. 5(A), the slider 43 has a pitch dynamic attitude which is slightly positive relative to the surface of the magnetic disk 3, but the roll dynamic attitude relative to the disk surface is nearly zero.

FIG. 5(B) shows a pressure distribution obtained when the roll static attitude of the slider 43 is inclined to the positive-side tolerance. At this time, the positive pressure on the side corresponding to the third pad constituting portion 438 of the leading pad 440 is slightly shifted to the trailing edge side in comparison with FIG. 5(A), but the shift quantity is small. The positive pressures at positions corresponding to the first and second pad constituting portions 436 and 437 of the leading pad 440 are little changed from the positions shown in FIG. 5(A). FIG. 5(C) shows a pressure distribution obtained when the roll static attitude of the slider 43 is inclined up to the negative-side tolerance. According to the pressure distribution shown therein, the positive pressure centers P in the leading pad 440 and the negative pressure centers N in the negative pressure portions 442 and 443 are little changed from the state shown in FIG. 5(A).

FIG. 5(D) shows a pressure distribution obtained when the pitch static attitude of the slider 43 is inclined up to negative-side tolerance, and FIG. 5(E) shows a pressure distribution obtained when the pitch static attitude of the slider 43 is inclined up to the positive-side tolerance. In the pressure distributions shown in FIGS. 5(D) and 5(E), the positive pressure centers P in the leading pad 440 and the negative pressure centers N in the negative pressure portions 442 and 443 scarcely exhibit any change in comparison with the state shown in FIG. 5(A). Particularly, such a pressure distribution as causes twist of the flying posture which occurred in the two-pad case in FIGS. 10(A) to 10(e) does not occur and therefore the flying stability of the slider 43 is improved. As shown in FIGS. 5(B) to 5(E), the reason the pressure distribution in an inclined state of the slider within the range of the maximum tolerance does not change so greatly from the state of the normal flying posture shown in FIG. 5(A) is that the three positive pressure pads 436, 437, and 438 are concentrated on the leading edge 431 side.

Thus, even upon displacement of the slider 43, there occurs little change in flying posture from the pressure distribution. Therefore, stable gimbaled motions can be performed not only in so-called Mini slider (100% slider), Micro slider (70% slider), Nano slider (50% slider), and Pico slider (30% slider) but also in Femto slider (20% slider) which is used together with a flexure weak in spring constant. A servo write test involving write to a magnetic disk was conducted with respect to the magnetic disk drive 1 using the slider 43 of the present embodiment and a magnetic disk drive using a conventional slider. According to the results obtained by this servo write test, a percent defective caused by interference of the slider with the magnetic disk is about 30% in the magnetic disk drive using the slider having a conventional air bearing surface. In the magnetic disk drive using the slider of the present embodiment, it could be confirmed that the percent defective decreased to several %.

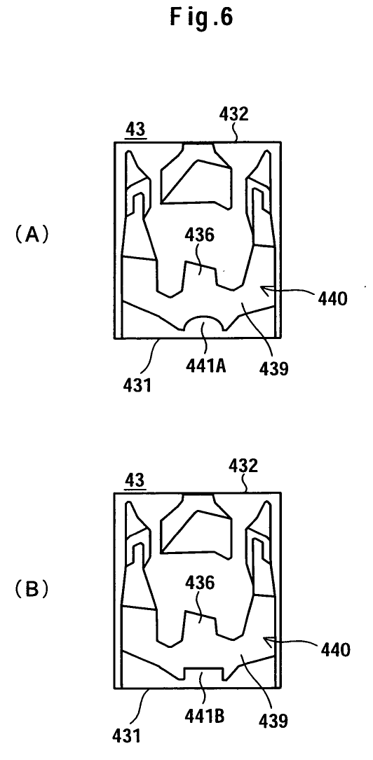

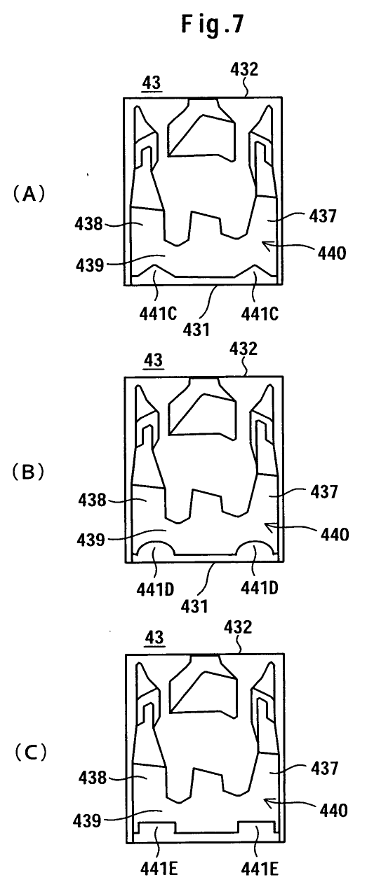

Although in the above magnetic disk drive according to one embodiment of the present invention, the air trap portion 441 formed in the connecting pad 439 in the leading pad 440 is a generally V-shaped creek, no limitation is made thereto. The air trap portion 441 may be such a generally U-shaped air trap portion 441A as shown in FIG. 6(A) or such a rectangular air trap portion 441B as shown in FIG. 6(B). The air trap portion may be formed in each of the position in the connecting pad 439 corresponding to the second pad constituting portion 437 and the position in the connecting pad 439 corresponding to the third pad constituting portion 438. There may be used such two generally V-shaped air trap portions 441C as shown in FIG. 7(A), such two generally U-shaped air trap portions 441D as shown in FIG. 7(B), or such two rectangular air trap portions 441E as shown in FIG. 7(C).

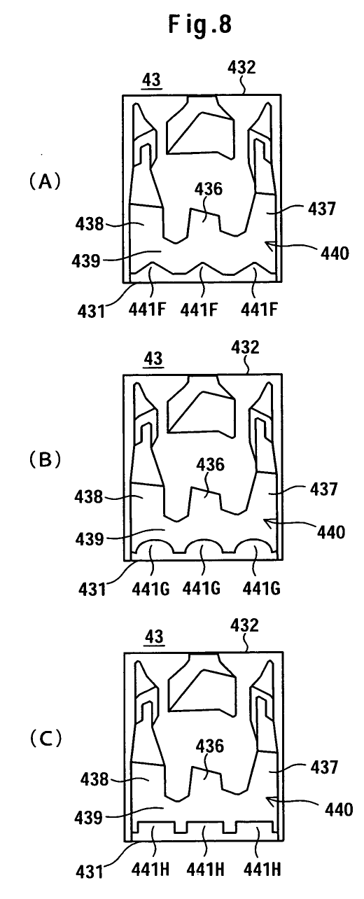

The air trap portion may be formed in each of the position in the connecting pad 439 corresponding to the second pad constituting portion 437, the position in the connecting pad 439 corresponding to the third pad constituting portion 438, and the position in the connecting pad 439 corresponding to the first pad constituting portion 436. There may be used such three generally V-shaped air trap portions 441F as shown in FIG. 8(A), such three generally U-shaped air trap portions 441G as shown in FIG. 8(B), or such three rectangular air trap portions 441H as shown in FIG. 8(C). Thus, the number of air trap portions in the roll direction and on the leading edge side of the leading pad 440 is increased. The air flow entering from the leading edge 431 stays in the air trap portions, and the air present therein can be conducted to each pad constituting portion in a larger amount and concentratively, so that the amount of the positive pressure can be further increased. Moreover, when air trap portions are formed correspondingly to the first, second, and third pad constituting portions 436, 437, and 438, there is no fear of the positive pressure becoming unbalance in the roll direction.

Further, in the above magnetic disk drive according to one embodiment of the present invention, the leading pad 440 is formed in W shape by the first, second, and third pad constituting portions 436, 437, and 438 and the connecting pad 439, but no limitation is made thereto. The leading pad 440 may be in any other shape insofar as it is formed on the leading edge side and has two creeks (negative pressure portions) on the trailing edge side and one creek (air trap portion) on the leading edge side. In this case, the position and the number of pressure centers of positive pressures developed in the leading pad vary depending on the shape and area of the leading pad.

Although in the above embodiments the slider 43 of the present invention is applied to the load/unload type magnetic disk drive, no limitation is made thereto. The slider of the present invention is also applicable to a magnetic disk drive of CSS (Contact Start Stop) type wherein the magnetic disk 3 has an unload area.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims alone with their full scope of equivalents.

1. A slider for use in a rotating disk type storage device, said slider having an air bearing surface, said air bearing surface comprising:
a first pad constituting portion extending from a leading edge side to a trailing edge side;
second and third pad constituting portions disposed on both sides of said first pad constituting portion and extending from said leading edge side to said trailing edge side;
a connecting pad for connecting said first, second, and third pad constituting portions on said leading edge side;
a first negative pressure portion formed by said first and second pad constituting portions and said connecting pad;
a second negative pressure portion formed by said first and third pad constituting portions and said connecting pad; and
an air trap portion formed on the leading edge side of said connecting pad.

2. The slider according to claim 1, wherein said air trap portion is formed in a shape selected from the group consisting of V shape, U shape, and a rectangular shape, and is provided in said connecting pad at a position corresponding to said first pad constituting portion.

3. The slider according to claim 1, wherein said air trap portion is formed in a shape selected from the group consisting of V shape, U shape, and a rectangular shape, and is provided in said connecting pad at each of positions corresponding to said second and third pad constituting portions.

4. The slider according to claim 1, wherein said air trap portion is formed in a shape selected from the group consisting of V shape, U shape, and a rectangular shape, and is provided in said connecting pad at each of positions corresponding to said first, second, and third pad constituting portions.

5. The slider according to claim 1, wherein said first, second, and third pad constituting portions are formed on said leading edge side with respect to a middle position between said leading edge and said trailing edge.

6. The slider according to claim 1, further comprising a center pad for a head on said trailing edge side with respect to a middle position between said leading edge and said trailing edge.

7. The slider according to claim 6, further comprising a first side pad and a second side pad on said trailing edge side with respect to the middle position between said leading edge and said trailing edge and on opposite sides of said center pad for the head.

8. The slider according to claim 7, wherein said first side pad and said second side pad are each formed in a generally U shape with a recessed portion open to the leading edge side.

9. The slider according to claim 7, wherein the surfaces of said first, second, and third pad constituting portions, said connecting pad, and said first and second side pads are flush with one another.

10. The slider according to claim 7, further comprising a first side rail connected between said second pad constituting portion and said first side pad, and a second side rail connected between said third pad constituting portion and said second side pad.

11. The slider according to claim 10, further comprising a first tail side rail formed on a trailing edge side of said first side pad, and a second tail side rail formed on a trailing edge side of said second side pad.

12. The slider according to claim 11, further comprising a center rail formed on a side of said center pad oriented toward said first pad constituting portion.

13. The slider according to claim 12, wherein the surfaces of said first and second side rails, said first and second tail side rails, and said center rail are flush with one another.

14. The slider according to claim 1, wherein said first, second, and third pad constituting portions and said connecting pad are formed in W shape.

15. The slider according to claim 1, having a profile dimension conforming to the standard of Femto slider.

16. The slider according to claim 1, wherein the surfaces of said first, second, and third pad constituting portions and said connecting pad are flush with one another.

17. A rotating disk type storage device comprising:
a rotating disk type recording medium;
a head configured to access said rotating disk type recording medium;
a slider carrying said head; and
an actuator assembly for moving said slider to a predetermined position over said rotating disk recording medium;
wherein said slider is the slider as recited in claim 1.

18. A slider for use in a rotating disk type storage device, comprising:
a reference surface surrounded with a leading edge, a trailing edge, a first side edge, and a second side edge; and
a leading pad formed on said leading edge side on said reference surface, said leading pad having two creeks on said trailing edge side and one creek on said leading edge side.

19. The slider according to claim 18, further comprising a step formed on said reference surface and between said leading pad and said leading edge, said step having a height from said reference surface which height is lower than said leading pad.

20. The slider according to claim 18, wherein said creeks are formed in a shape selected from the group consisting of V shape, U shape, and a rectangular shape.

21. The slider according to claim 18, wherein the whole of said leading pad is formed on said leading edge side with respect to a middle position between said leading edge and said trailing edge.

22. A rotating disk type storage device comprising;
a rotating disk type recording medium;
a head configured to access said rotating disk recording medium;
a slider carrying said head; and
an actuator assembly for moving said slider to a predetermined position over said rotating disk type recording medium;
wherein said slider is the slider as recited in claim 18.
